(19) United States
(12) Patent Application Publication
(10) Pub. No.: US 2023/0230385 A1
(43) Pub. Date: Jul. 20, 2023

(54) METHOD FOR GENERATING AT LEAST ONE BIRD'S EYE VIEW REPRESENTATION OF AT LEAST A PART OF THE ENVIRONMENT OF A SYSTEM

(71) Applicant: Robert Bosch GmbH, Stuttgart (DE)

(72) Inventors: Denis Tananaev, Sindelfingen (DE); Ze Guo, Berlin (DE)

(21) Appl. No.: 18/154,431

(22) Filed: Jan. 13, 2023

(30) Foreign Application Priority Data
Jan. 18, 2022 (DE) 10 2022 200 508.2
Dec. 22, 2022 (DE) 10 2022 214 336.1

(51) Int. Cl. G06V 20/56; G06T 3/40; G06V 10/44; G06V 10/80

(52) U.S. Cl. CPC G06V 20/56; G06T 3/40; G06V 10/44; G06V 10/806; G06V 2201/07

(57) ABSTRACT

A method for generating at least one representation of a bird's eye view of at least a part of the environment of a system, based on at least one or more digital image representations obtained from at least one or more cameras of the system. The method comprises: a) obtaining a digital image representation (2) advantageously representing a single digital image, together with at least one camera parameter of the camera that captured the image, b) extracting at least one feature from the digital image representation, wherein features are generated in different scales, c) transforming the at least one feature from the image space into a bird's eye view space, to obtain at least one bird's eye view feature.

### FIELD

The present invention relates to a method for generating at least one bird's eye view representation of at least a part of the environment of a system, particularly based on at least one or more digital image representations advantageously obtained from at least one or more cameras of the system, advantageously a vehicle. Moreover, a computer program for performing the method and a machine-readable storage medium with the computer program are provided. Further, an object detection system for a vehicle is indicated.

### BACKGROUND INFORMATION

In advanced driver assistance systems or autonomous driving systems, a perception system is typically used to provide a representation of the 3D environment, and this representation may serve as input for a motion planning system that is able to decide how to maneuver the ego vehicle. A key technology of the perception system is to recognize where the vehicle can go and what the environment around the vehicle looks like. The conventional method of employing classical computer vision techniques is complex because many detection algorithms need to be developed and a fusion step is required to gain an overview of the 3D environment; this complicated process can also be computationally intensive.

An objective of the present invention is to greatly simplify a corresponding method and, in particular, to use the performance of deep learning to directly predict the final representation that may be used for motion planning.

### SUMMARY

According to the present invention, a method for generating at least one bird's-eye view representation of at least a part of the environment of a system is provided. According to an example embodiment of the present invention, the method comprises at least the following steps:
a) obtaining a digital image representation,
b) extracting at least one feature from the digital image representation,
c) transforming the at least one feature from the image space into a bird's eye view space.

To perform the method, steps a), b) and c) may be performed for example at least once and/or repeatedly in the order indicated.

Furthermore, steps a), b) and c) may be performed at least in part in parallel or simultaneously. The method can be implemented, for example, by means of a system or object detection system described here.

According to an example embodiment of the present invention, the method is in particular used to generate at least one image representation and/or environmental representation from a bird's eye view of at least a part of the environment of a system. This is done in particular based on at least one or more digital image representations. The digital image representations may advantageously be obtained from at least one or more cameras of the system.

For example, the system may be a vehicle, such as a motor vehicle. For example, the vehicle may be an automobile. The vehicle or system may be configured for at least partially automated or autonomous (driving) operation.

According to an example embodiment of the present invention, in step a), a digital image representation is obtained. The digital image representation may advantageously represent or be a single digital image. The digital image representation can in particular be obtained together or in combination with at least one camera parameter. Advantageously, the camera parameter may be an intrinsic camera parameter. The camera parameter is typically one of the camera that captured the image.

According to an example embodiment of the present invention, in step b), there is an extraction of at least one feature from the digital image representation. In this context, features are advantageously produced at different scales. For example, features may be produced at a first scale and a second scale, wherein the first scale is greater than or less than the second scale. In particular, the same feature may be generated in the various scales.

According to an example embodiment of the present invention, in step c), the at least one feature is transformed from the image space into a bird's eye view space. The image space may be a two-dimensional or three-dimensional space, which may be represented by the optical detection or a detection range of the obtained digital image representation. In particular, it can be an observational range or detection range of one or more cameras from which the digital image representation has been obtained. The transforming is preferably done with the objective of obtaining at least one bird's eye view feature. The bird's eye view feature contributes in particular to describing the observed scene of the environment from above. The bird's eye view feature may comprise a relative position element for describing its position relative to the system.

An advantageous embodiment of the method of the present invention provides a new framework for training an (artificial) continuous deep neural network, the output of which can be used to describe the 3D environment surrounding the ego vehicle in advanced driver assistance systems/autonomous driving systems. For example, the continuous deep neural network may also be described as an end-to-end deep neural network.

According to one advantageous configuration of the present invention, it is provided that the method for training a system and/or a deep learning algorithm is performed in order to describe at least a part of the 3D environment around a system. For example, the method of training a continuous deep neural network may be performed. In particular, this may be an end-to-end deep neural network. It may advantageously be a convolutional neural network (CNN). The method may be particularly advantageous for the in particular automated generation of training data for the training of the artificial neural network or the algorithm.

A goal of a perception system or object detection system of advanced driver assistance systems or autonomous driving systems may be to obtain a so-called bird's eye view (BEV) representation for further motion planning. In this context, it may be helpful to fuse the semantic and 3D information of various sensors into a so-called bird's eye view (BEV) representation for further motion planning. According to one advantageous embodiment of the present invention, in this context, an end-to-end BEV semantic map prediction may be used. An encoder-decoder segmentation architecture may advantageously be used to directly learn the BEV transformation. However, these methods are typically not general solutions, as they typically cannot handle images from unseen cameras (camera images that do not occur in the training set) that have different camera-intrinsic parameters. In addition, the performance of these methods is typically limited due to the architecture design. The method provided here may help solve these problems.

An advantageous embodiment of the present invention may comprise at least one or more of the following aspects:
A unified deep neural network may be introduced to directly predict the semantic segmentation of the BEV and the object/surface elevation map.
It may introduce a new building block for the effective transformation of the feature space from the image plane to the BEV plane.
It may introduce a method for normalization across different cameras so that images from different cameras may be used for training and the trained model may advantageously work with images from different cameras.

An advantageous embodiment of the present invention may have at least one or more of the following advantages:
Particularly when using the proposed building blocks, a deep neural network may advantageously effectively learn the view transformation from camera parameters and image data, which provides advantageously good prediction results for semantic classes in the BEV, particularly when sufficient data are provided in the training phase. It can greatly simplify the perception system as it can directly predict the BEV map, which has the advantage that the system does not have various complex algorithms and/or must subsequently fuse these with one another.
An algorithm for performing at least part of the invention advantageously allows data from different cameras to be combined with different intrinsic parameters for training a neural network. This may allow for the reuse of existing training data for new projects and advantageously saves costs. In addition, already trained networks can be applied to various cameras without retraining. This advantageously reduces the effort involved in the development process.
The invention can advantageously enable the same autonomous capabilities for pure camera systems as for systems that include expensive active sensors (e.g. LiDAR, radar, etc.).

According to a preferred embodiment of the present invention, the method may include a continuous (end-to-end) semantic map prediction from the bird's-eye view for the 3D environment reconstruction and/or motion planning, particularly using deep neural networks.

An advantageous embodiment of the method of the present invention may comprise at least one or more of the following parts or steps:
An end-to-end semantic segmentation and elevation prediction for BEV.
A unique and effective neural network building block for the BEV prediction.
Method for using data from different cameras and generalization of the algorithm to different cameras.

An advantageous embodiment of the method of the present invention may include an automatic generation of ground truth from the bird's eye view (BEV).

An advantageous embodiment of the present invention may include a continuous (end-to-end) semantic segmentation and elevation prediction in bird's-eye view or BEV.

The generation according to the method may comprise machine and/or automated generation. The representation may include a representation of the environment (in the system) from the bird's eye view (abbreviated: BEV). The representation is preferably a ground truth representation. Alternatively or cumulatively, the representation may include a digital (environmental) map, such as a highly accurate environmental map or HD map (high definition map) or a representation for monitoring the road and/or traffic infrastructure.

The “ground truth” may in particular comprise a plurality of data sets that describe a basic knowledge for training a machine learning algorithm and/or a machine learning system, such as an artificial neural network. The basic knowledge can in particular relate to a sufficient number of data sets in order to be able to train a corresponding algorithm or a corresponding system for an image evaluation.

The term “ground truth” may alternatively or additionally relate herein to, for example, a ground reality, ground truth and/or field comparison. Ground truth generation advantageously makes it possible that, in the analysis of information from the representation, ground truth data, particularly ground data and/or data for describing the ground (position and/or path) can be taken into account in the representation (of the environment). The ground truth data may in particular provide additional information and/or reference information about circumstances and/or dimensions and/or proportions in the representation. The ground truth data may in particular help to describe where a (potential) object is standing on the ground or comes into contact with the ground detectable in the representation. For example, the ground truth data may help to more specifically capture or describe a (reference) object in the representation. In particular, the ground truth data may help to ensure that information from the representation is more precisely classified and/or that the result of the classification can be checked for correctness. Thus, the ground truth data may particularly advantageously contribute to training a machine learning algorithm and/or a machine learning system, in particular an artificial neural network.

According to a further advantageous configuration of the present invention, it is provided that the conversion in step c) comprises a feature compression. In particular, from each feature of the extracted image features, initially the features along the vertical axis may be compressed, particularly through successive convolution layers advantageously with stride 2 (or 2\hat{ }N) along the vertical axis.

According to another advantageous configuration of the present invention, it is provided that the transformation in step c) comprises a feature expansion. Particularly in the condensed feature vectors, the next step may be to expand the feature along the vertical axis in order to create a corresponding feature in bird's eye view. To achieve this, a depth range (vertical axis) in real meters may advantageously be pre-defined as hyperparameters.

According to another advantageous configuration of the present invention, it is provided that the transformation in step c) comprises an inverse perspective mapping feature generation. Inverse perspective mapping (IPM) is a method that can be advantageously used to project an image onto the bird's eye view, particularly assuming a flat ground level.

According to another advantageous configuration of the present invention, it is provided that the transformation in step c) comprises resampling of features. In particular, a bilinear sampling may be used for resampling an image grid or raster.

According to another advantageous configuration of the present invention, it is proposed that the transformation in step c) comprises a feature fusion. In particular, bird's-eye view features in the pixel grid may be resampled and may all be of the same shape; they may be fused (summed) together with the IPM features to form the final bird's-eye view features.

According to a further advantageous configuration of the present invention, it is provided that a camera normalization is performed. The camera normalization can in particular be carried out dependent on the at least one camera parameter. The camera normalization may be performed in particular with the purpose that the method is able to work with images from different cameras (with different intrinsic parameters).

In another aspect of the present invention, a computer program for performing a method presented herein is provided. In other words, this relates in particular to a computer program (product) comprising instructions that, when the program is executed by a computer, cause the computer to perform a method described herein.

According to a further aspect of the present invention, a machine-readable storage medium is provided on which the computer program provided herein is saved or stored. Normally, the machine-readable storage medium is a computer-readable data carrier.

In another aspect of the present invention, an object detection system for a vehicle may be indicated, wherein the system is configured to perform a method described, and/or the system at least comprises:
a multi-scale backbone, and
a bird's eye view transformation module, and
optionally a feature refinement module.

The system or object detection system according to an example embodiment of the present invention may comprise a computer and/or a controller that is able to execute instructions in order to perform the method. For this purpose, the computer or the controller may execute the specified computer program, for example. For example, the computer or the controller may access the specified storage medium in order to execute the computer program.

The details, features and advantageous configurations discussed in connection with the method of the present invention may also occur in connection with the computer program of the present invention and/or storage medium of the present invention and/or the object detection system of the present invention, and vice versa. In this respect, reference is made to the totality of the respective statements regarding the more detailed characterization of the features.

The approach presented here as well its technical environment are explained in further detail below with reference to the figures. It should be noted that the present invention is not to be limited by the embodiment examples shown. In particular, unless explicitly indicated otherwise, it is also possible to extract partial aspects of the facts explained in the figures and to combine them with other parts and/or findings from other figures and/or the present description.

### BRIEF DESCRIPTION OF THE DRAWINGS

FIG. 1 shows an exemplary sequence of a method according to the present invention.

FIG. 2 shows an example of an object detection system according to the present invention described herein.

FIG. 3 shows an illustration of an exemplary application of the method according to the present invention.

FIG. 4 shows an illustration of an exemplary aspect of the method of the present invention.

FIG. 5 shows an illustration of an exemplary aspect of the method of the present invention.

FIG. 6A-6C show an illustration of an exemplary application of the method of the present invention.

FIG. 7 shows an illustration of an exemplary aspect of the method of the present invention.

FIG. 8 shows an illustration of an exemplary aspect of the method of the present invention.

FIG. 9 shows an illustration of an exemplary aspect of the method of the present invention.

### DETAILED DESCRIPTION OF EXAMPLE EMBODIMENTS

FIG. 1 schematically shows an example of a sequence of a method proposed herein. The method is for generating at least one representation 1 from a bird's eye view of at least a part of the environment of a system, particularly based on at least one or more digital image representations 2 advantageously obtained from at least one or more cameras of the system, advantageously a vehicle. The sequence of steps a), b) and c) shown by blocks 110, 120 and 130 is exemplary and may be run through, for example, at least once in the order shown to perform the method.

In block 110, according to step a), a digital image representation 2 is obtained, which advantageously represents a single digital image, in particular together with at least one camera parameter 3, advantageously an intrinsic camera parameter, of the camera that captured the image.

In block 120, according to step b), at least one feature 4 is extracted from the digital image representation 2, wherein advantageously features 4 are generated in different scales 5.

In block 130, according to step c), the at least one feature 4 is transformed from the image space 6 into a bird's eye view space 7, advantageously to obtain at least one bird's eye view feature 8.

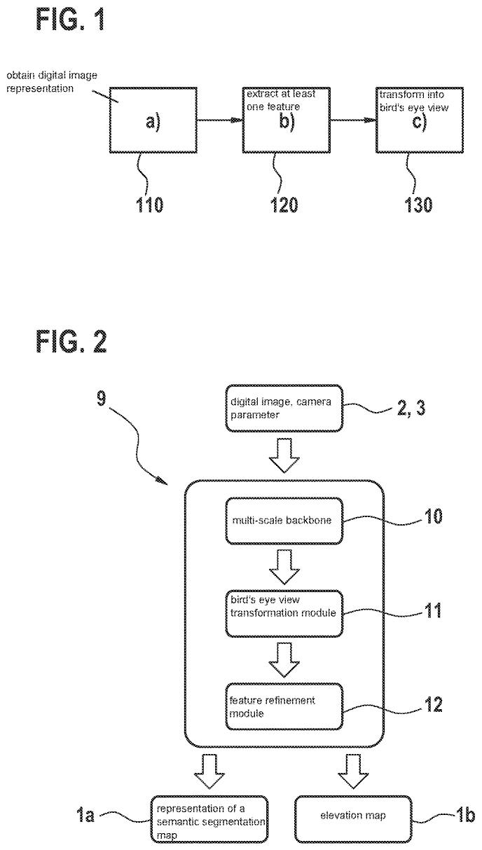

FIG. 2 schematically shows an example of a sequence of an embodiment variant of the here-proposed object detection system 9 for a vehicle. The system is configured to perform the method described in FIG. 1. The system includes a multi-scale backbone 10, a bird's eye view transformation module 11, and a feature refinement module 12.

In this connection, FIG. 2 schematically shows an example of an overview of a system with a deep neural network for the transformation into the bird's eye view.

For example, a single digital image 2 can be supplied as an input to the system 9. The image 2 may be supplied together with a camera parameter 3, from the camera with which the image 2 was recorded. The system 9 outputs at least one representation 1 from the bird's eye view of at least a part of the environment as an output. The input and the outputs may be respective inputs and outputs of a neural network. For example, the outputs here may be a representation la of a semantic segmentation map as well as a representation of an elevation map with estimated object elevations, respectively in a bird's eye view.

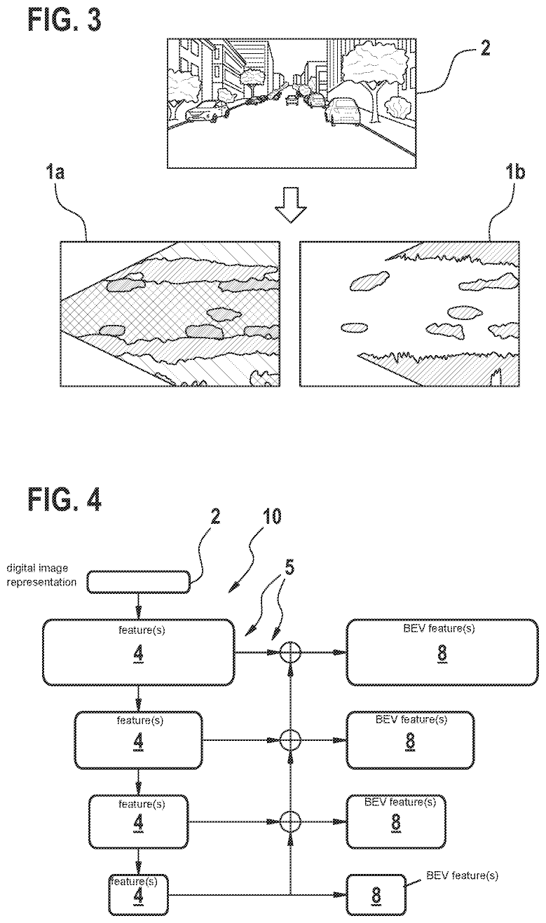

FIG. 3 shows an illustration of an exemplary application of the method. In particular, real examples of the input and outputs of the system of FIG. 2 are shown. FIG. 3 thus shows an example of the input and output of a deep neural network for the transformation into the bird's eye view according to the method described herein.

In particular, if the method is to be based on supervised learning, then label data are normally required for the training phase of the deep neural network. The following labeling data are advantageous:
Semantic segmentation map in BEV or bird's eye view
Elevation map in the BEV or in bird's eye view

Examples of corresponding label data can also be seen in FIG. 3.

The label data may advantageously be obtained from a semantically labeled point cloud, a corresponding camera image and/or sensor position information. An input of the method/algorithm may be: single image+camera parameters. An output of the method/algorithm may be: semantic segmentation map and/or object/surface elevation map in BEV.

An overview of an exemplary architecture can be seen in FIG. 2. An example of the results of the system is shown in FIG. 3.

In a preferred embodiment, a deep neural network may predict semantic segmentation map 1a and/or the corresponding elevation map 1b for each pixel in the segmentation map directly from the bird's eye view.

In particular, a deep neural BEV network according to a preferred embodiment may comprise the following:
a multi-scale backbone 10,
a BEV view transformation module 11,
a feature refinement module 12.

The multi-scale backbone 10 may be or include a feature extractor (e.g., a convolutional neural network) that may take an image 2 as input and generate (high-level) features advantageously at various scales, e.g. ⅛, 1/16, 1/32, 1/64 of the input size. In particular, a neural network architecture can be used as a backbone, e.g. a feature pyramid network (FPN) and/or an inception network. An example of the backbone structure is shown in FIG. 4, particularly on the left side of FIG. 4. Features 4 extracted from the digital image representation 2 are illustrated at various scales 5. In parallel, on the right hand side, the corresponding different scales 5 for BEV features 8 generated from the features 4 are indicated. Upsampling can occur between scales 5, respectively.

Thus, FIG. 4 schematically illustrates an example of a backbone structure 10 for detecting multi-scale features.

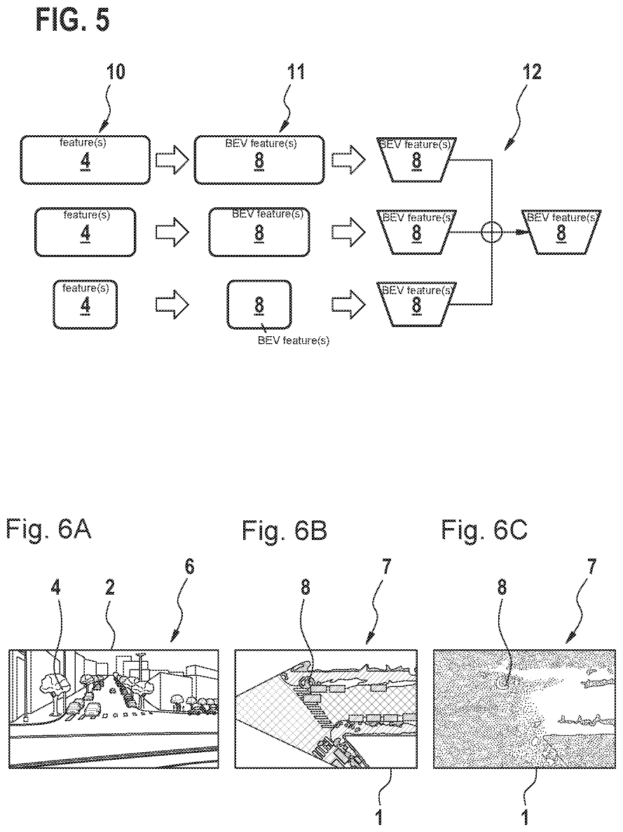

In particular, each of the multi-scale features 4 may be fed into a BEV view transformation module 11 (an exemplary embodiment of which will be described in detail further below) in order to obtain the BEV feature 8. An exemplary overview of the BEV view transformation module 11 is shown in FIG. 5.

An obtained BEV feature may be the input for a module 12 for feature refinement, which may include a cascade of convolutional layers+stack normalization+activation (e.g., Leaky ReLU) or ResNet blocks, which are able to refine the BEV feature 8 further. In module 12, the individual bird's eye view features 8 can also be combined into one feature (merged BEV feature in full bird's eye view).

In particular, two task heads may be created from the refined BEV feature 8:
Segmentation head of the form h_BEV×w_BEV×C (C is the number of classes)
Elevation head of the form h_BEV×w_BEV×1

Thus, FIG. 5 schematically shows an example of a transformation from a multi-scale image feature 4 to a BEV feature 8.

The advantageous embodiment may be described using the following example of a single (front) camera view: If only one camera view, e.g. the front camera view, is viewed, the BEV ground truth may cover an area of e.g. 40 m width and 60 m length, with a pixel grid resolution of e.g. 0.1 m/pixel, i.e. the BEV ground truth map may have a shape of e.g. 400×600 (40/0.1, 60/0.1) in pixels. The initial shape of the deep neural network can be, for example, 400×600×1 for the elevation map and 400×600×C for the segmentation map, where C is the number of semantic classes. To obtain the final class index map, the argmax operation can be applied along the class axis.

An advantageous embodiment of the method may comprise an advantageously unique and effective neural network building block for the BEV prediction.

A particularly advantageous building block in this context can be a BEV view transformation module 11, which is able to transform the features from the image feature space 6 into the feature space 7 of the bird's eye view. An input of the transformation may be: Multi-scale image features 4 from the backbone network 10. An output of the transformation may be: BEV feature 8.

An exemplary overview of the BEV view transformation module 11 is shown in FIG. 5. Possible application examples are shown in FIGS. 6A-6C.

FIGS. 6A-6C show an example of generating a BEV ground truth result.

FIG. 6A shows the original RGB image, which can form an input of the method as a digital image representation 2. FIG. 6B shows a semantic segmentation BEV map; FIG. 6C shows an elevationmap. All in the view of a front camera. The segmentation map and the elevation map are advantageous examples of representations 1 from a bird's eye view to be generated by the method.

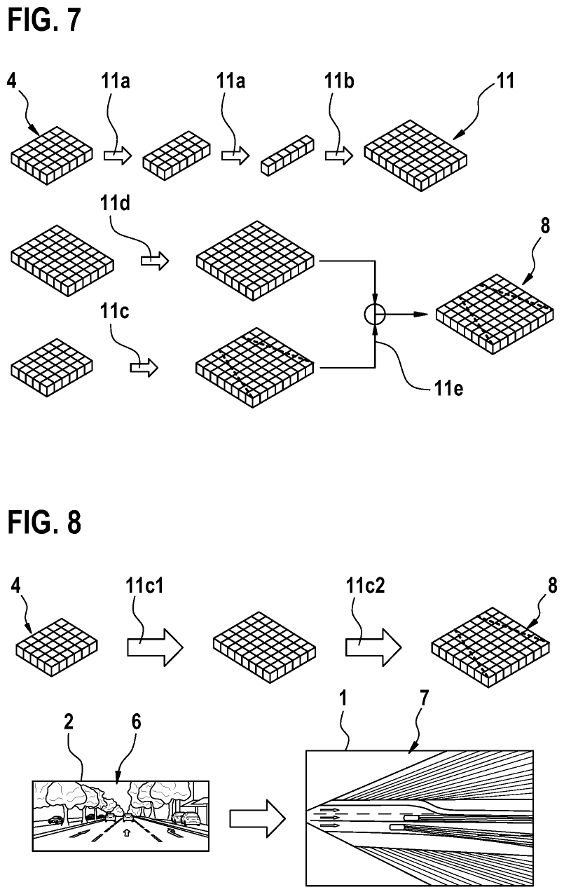

FIG. 7 schematically illustrates an example of an overview of a BEV view transformation or a BEV view transformation module 11.

As the name of this module 11 suggests, it aims to transform the features 4 obtained from the image (image space 6) into the space 7 of the bird's eye view, so that a network can preferably learn better features 8 that lead to better performance.

A particularly advantageous embodiment of the bird's eye view transformation module 11 or BEV view transformation module 11 and/or the BEV transformation may comprise at least one or more or all of the following steps/parts:
Feature compression
Feature expansion
Inverse perspective mapping feature generation
Re-sampling of features
Feature fusion

The transformation may comprise a feature compression (feature condensing).

In particular, of each feature of the multi-scale features from the backbone, the features along the vertical axis may first be compressed, in particular through successive convolution layers advantageously with stride 2 (or 2\hat{ }N) along the vertical axis. An exemplary overview of the feature compression is shown in FIGS. 6A-6C. The parameters of the example are as follows: Feature size: C×64 (height)×128 (width) (at a stride of 4, with 2 convolution layers)->C×16×128->C×4×128

An example of the feature compression is shown in FIG. 7 at the top left with arrows 11a, based on the compression of the height H to H1 and H2.

The transformation may comprise a feature expansion (feature splatting).

Particularly in the case of the condensed feature vectors, the next step may be to expand the feature along the vertical axis in order to create a corresponding feature in bird's eye view. To achieve this, a depth range (vertical axis) in real meters can advantageously be pre-defined as hyperparameter, e.g. 0-60 m. At a predefined pixel grid resolution of e.g. 0.1 m/pixel, the depth range in pixels (Z) may be calculated as (range_max−range_min)/pixel_grid_resolution, i.e. (60−0)/0.1=600 in the example above.

When the depth range is defined in pixels (Z), the feature splatting aims to restore the height dimension of the condensed feature map in Z by first performing a 1×1 convolution and then a transformation operation, for example:

Goal: C×4×128->C×Z×128

1×1 convolution with filter size C*Z*1/4: (C*Z*1/4)×4×128

Transformation: (C*Z*1/4)×4×128->C×Z×128

An exemplary overview of the feature splatting is shown in FIG. 7 on the upper right with arrow lib, e.g. by the expansion of H or H2 to Z.

The transformation can include an inverse perspective mapping feature generation (IPM feature generation).

Inverse perspective mapping (IPM) is a method that can be advantageously used to project an image onto the bird's eye view, particularly by assuming a flat ground level. With a (almost) level surface, it can achieve reasonable results, but as soon as the surface has a considerable height (e.g., in the case of automobiles), the result may appear highly distorted.

An exemplary application of an IPM transformation is shown on the lower left side of FIG. 7 with arrow 11c. Particularly from the dimensions H, W, C to Z, X, C.

As part of the method, IPM can advantageously be applied to any multi-scale feature 4 in order to convert it from the image plane 6 into the BEV plane 7. However, the ground level is not always level in practice, so that errors can occur in the resulting feature. Therefore, after the generation of the IPM features, a convolutional layer (or multiple layers) may be added. Because the entire process is advantageously differentiable, a network can learn to compensate for this error. In this way, the IPM feature can act like a previous feature and guide the network to create a better final BEV feature.

An example of the application of an inverse perspective mapping feature generation (IPM) in the real case is shown in FIG. 8.

The transformation may comprise a re-sampling of features (feature re-sampling).

As described above for the feature expansion or “feature splatting”, a BEV pixel grid may be defined based on the width (X) and depth (Z) in meters and a pixel grid resolution (r, m/pixel). The grid size in pixels may be (X/r, Z/r).

With the exemplary intrinsic matrix of the camera

$$( M = \begin{matrix}{f}_{x} & 0 & {c}_{x} \\ 0 & {f}_{y} & {c}_{y} \\ 0 & 0 & 1\end{matrix} ) ,$$

a resampling can be performed in order to map the feature values from the BEV feature space (Z×W×C) into a BEV grid space or bird's eye view grid space (Z×X×C).

$$[ \begin{matrix}x \\ z\end{matrix} ] = [ \begin{matrix}{f}_{x} & 0 & {c}_{x} \\ 0 & 0 & 1\end{matrix} ] [ \begin{matrix}X \\ Z\end{matrix} ] , \\ x = \frac{{f}_{x} X}{Z} + {c}_{x}$$

A bilinear sampling may be used for the resampling of the grid or raster.

An example of the resampling of features is shown centrally in FIG. 7 with arrow 11d.

The transformation may comprise a feature fusion (feature merging).

The BEV-features may be resampled in the pixel grid and may all be of the same shape; they may be fused (summed) together with the IPM features to form the final BEV feature 8. An example of this is shown on the right of FIG. 7 with arrow lle.

The fused BEV features 8 can be used as input for the segmentation and the height estimate of the task heads for the final prediction.

FIG. 8 schematically shows an example of the application of an inverse perspective mapping feature generation (IPM) in the real case. Arrow 11c1 shows that the actual IPM transformation may include a transformation step, shown here with arrow 11c1, and a resampling step, shown here with arrow 11c2.

For example, the method may comprise a camera normalization, in particular as a function of the at least one camera parameter 3.

A particularly advantageous aspect of the method is that it can train/work with images from different cameras (with different intrinsic parameters).

A major cause of a possible performance drop of a CNN (Convolutional Neural Network) on various autonomous mobile robotic systems or self-driving cars may be a gap between the training data and the sensor data from the field. Even when the training data were collected from the sensors of the mobile robotic system, the performance in similar robots may decrease due to errors and inaccurate installation of the sensor positions. The position of the camera can be associated with its extrinsic parameters representing the x, y, and z positions, as well as the roll, pitch, and yaw angles. The slight differences in the intrinsic and distortion coefficients and/or the differences in the projection model of the cameras (e.g., fish eye, pinhole aperture) can increase the complexity of the CNN so that it is able to generalize well in all of these cases.

The method may help to reduce the complexity of the multi-camera system. In particular, an introduction of a virtual camera can be made with, for example, a fixed intrinsic, distorting, extrinsic, and/or camera model, and/or the reprojection of all sensor cameras onto the given virtual camera.

An advantageous aspect may be the handling of various in-camera or intrinsic parameters 3.

As mentioned in the above algorithm, in particular the focal length of the camera may affect the depth range in the BEV view. This means that the network, which can be trained on images from one camera, can usually not generate the correct depth on input images originating from another camera having a different focal length. In an advantageous further development, the method, aims in particular to solve this problem and advantageously realizes at least one or two of the following:
Training with images from different cameras
Prediction of a meaningful result on images from different cameras

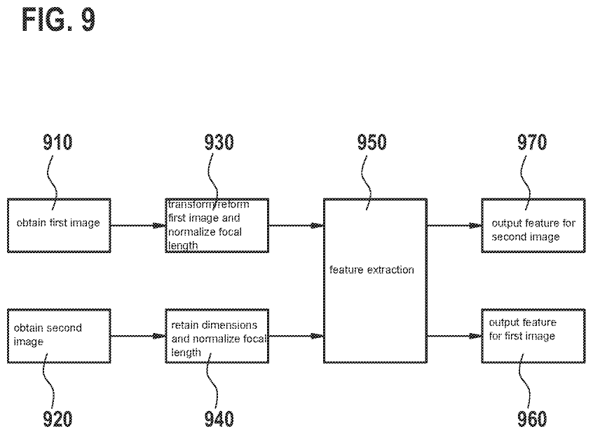

An exemplary overview of this method is shown in FIG. 9. In this connection, FIG. 9 shows an example of an overview of the use of the nominal focal length and the orientation of the shape of the feature, with: nominal focal length: f_c=f2; reshaping factor: f_c/f

In the example, in block 910, a first image may be obtained having a dimension H×W (image representation 2) and focal length f1 (camera parameter 3). In block 920, a second image may be obtained having a dimension H×W and a focal length f2=f1/2. In block 930, the first image may be transformed or reformed to the H/2×W/2 dimension, with a normalized focal length f_c. In block 940, the second image may retain its H×W dimension and the second image is associated with the normalized focal length f_c. In block 950, both images are subjected to feature extraction in a backbone. Moreover, in block 950, the images may also be subjected to an alignment using a roll-aligning layer. In block 960, a feature of the dimension h_f×w_f is output for the first image. In block 970, a feature of the dimension h_f×w_f is output for the second image.

In particular, a nominal focal length (f_c) may be used, and the input images may be normalized with respect to this focal length, i.e. the size of the input images is changed by a factor of f_c/f, where f is the focal length of the respective camera used. The change in size may result in different input shapes for the network. To compensate for the scale difference, a roll-orientation layer or a roll-aligning layer can be used to assimilate the feature shapes, i.e., despite different input image shapes, the final extracted feature map or feature representation can advantageously always have same shape.

One advantageous aspect may be dealing with different camera rotations. A corresponding method may comprise steps as described below:

The method may comprise calculating rotational compensation.

Particularly with given original camera rotation roll_{raw}, pitch_{raw}, yaw_{raw} the rotation of the camera can be compensated for in order to obtain the exact rotation of the camera in the training data set roll_{correct}, pitch_{correct}, yaw_{correct}. In particular, the orientation of the raw camera can be represented as a rotation matrix world_T_raw_cam ∈ R^{3×3} and the correct orientation as world_T_correct_cam ∈ R^{3×3}; the rotation from the raw camera to the correct one can then occur as follows:

correct_cam_T_raw_cam=inv(world_T_correct_cam)*world_T_raw_cam (1)

In this regard, correct_cam_T_raw_cam ∈ R^{3×3}—the transformation of the camera from the raw orientation to the correct orientation, inv( )—corresponds to the inverse matrix operation, *—denotes a point product operation.

The method may comprise determining the beams corresponding to any desired raw camera.

In particular, a raw camera distortion model may be referred to as raw_distortion_model. This model may obtain as input the normalized image coordinate (z=1) from the undistorted image and provide the corresponding coordinate for the distorted image. In particular, simultaneously an inverse distortion model inv_raw_distortion_model may obtain normalized image coordinates (z=1) for the distorted image and provide the corresponding position on the undistorted image. In particular, a projection model may be referred to as raw_projection_model. This model can project the beam from the 3D space onto a 2D image. In particular, an inverse projection model may simultaneously be referred to as inv_raw_projection_model which can obtain 2D image coordinates and project these into the 3D space. The raw camera intrinsics may be referred to as raw_intrinsic.

To find 3D beams, the following may be performed:

raw_3d_rays=inv_raw_projection_model(inv_raw_distortion_model(inv(raw_intrinsic)*pixels_coordinates)) (2)

The method may comprise rotational compensation.

3d_rays_correct=correct_cam_T_raw_{cam}*raw_3d_rays (3)

The method may comprise a projection onto a virtual correct camera.

In particular, the model of the correct camera distortion may be referred to as correct_distortion_model. This model may obtain as input the normalized image coordinate (z=1) of the undistorted image and provide the corresponding coordinate of the distorted image. In particular, the projection model may be referred to as correct_projection_model. This model may project the beams from the 3D space onto 2D unit beams (z=1). The correct camera intrinsics may be referred to as correct_intrinsic. A correct virtual camera image may be created as follows:

correct_image=correct_intrinsic*correct_distortion_model(correct_projection_model(3d_rays_correct)) (4)

The corrected image may advantageously have an exact intrinsic and extrinsic, distortion and projection model like the camera in the training time; therefore, the domain gap may advantageously be reduced, in particular not only for the same camera types (e.g., pinhole), but also advantageously across different camera geometry types (e.g., fisheye, omnidirectional cameras, etc.).

1-11. (canceled)

12. A method for generating at least one representation of a bird's eye view of at least a part of the environment of a system, the method comprising the following steps:
a) obtaining a digital image representation'
b) extracting at least one feature from the digital image representation; and
c) transforming the at least one feature from the image space into a bird's eye view space.

13. The method according to claim 12, wherein the method is performed for training a system and/or a deep learning algorithm in order to describe at least a part of a 3D environment around the system.

14. The method according to claim 12, wherein the transforming of step c) includes a feature compression.

15. The method according to claim 12, wherein the transforming of step c) includes a feature expansion.

16. The method according to claim 12, wherein the transforming of step c) includes an inverse perspective mapping feature generation.

17. The method according to claim 12, wherein the transforming of step c) includes a resampling of features.

18. The method according to claim 11, wherein the transforming of step c) includes a feature fusion.

19. The method according to claim 11, further comprising performing a camera normalization.

20. A non-transitory machine-readable storage medium on which is stored a computer program for generating at least one representation of a bird's eye view of at least a part of the environment of a system, the computer program, when executed by a computer, causing the computer to perform the following steps:
a) obtaining a digital image representation'
b) extracting at least one feature from the digital image representation; and
c) transforming the at least one feature from the image space into a bird's eye view space.

21. An object detection system for a vehicle, the system comprising:
a multi-scale backbone; and
a bird's eye view transformation module;
wherein the system is configured to generating at least one representation of a bird's eye view of at least a part of the environment of the system, the system being configured to:
a) obtain a digital image representation;
b) extract at least one feature from the digital image representation; and
c) transform the at least one feature from the image space into a bird's eye view space

22. The system according to claim 21, further comprising a module for feature refinement.
